(19) United States
(12) Patent Application Publication
(10) Pub. No.: US 2007/0230722 A1
(43) Pub. Date: Oct. 4, 2007

(54) Condenser microphone

(76) Inventors: Mitsuyoshi Mori, Kyoto (JP); Daisuke Ueda, Osaka (JP)

Correspondence Address: MCDERMOTT WILL & EMERY LLP, 600 13TH STREET, NW, WASHINGTON, DC, 20005-3096, US

(21) Appl. No.: 11/651,024

(22) Filed: Jan. 9, 2007

(30) Foreign Application Priority Data
Mar. 29, 2006 (JP) 2006-092351

(51) Int. Cl. H04R 25/00

(52) U.S. Cl. 381/174; 381/178

(57) ABSTRACT

An electret condenser microphone (ECM) forms an air-gap capacitor structure in which an upper electrode and a lower electrode are opposed to each other with its hollow portion interposed therebetween, and an electret film made of a charge retention material is formed between the electrodes. The ECM is formed continuously with a semiconductor substrate, and the electret film is made of an amorphous perfluoropolymeric resin. The electret film made of such a material can be formed on the substrate by spin coating. This facilitates reducing the thickness of the electret film. In addition, the film can be easily etched by a fluorine based gas used in a semiconductor process. This permits fine patterning, resulting in the reduced area of a condenser.

### CROSS-REFERENCE TO RELATED APPLICATIONS

The disclosure of Japanese Patent Application No. 2006-092351 filed on Mar. 29, 2006 including specification, drawings and claims is incorporated herein by reference in its entirety.

### BACKGROUND OF THE INVENTION

(1) Field of the Invention

The present invention relates to electret condenser microphones (ECMs), and more particularly relates to an electret condenser microphone formed continuously with a semiconductor substrate so as to be reduced in size.

(2) Description of Related Art

In recent years, electret condenser microphones representing acoustic sensors have been incorporated into widely used cell phones.

FIG. 5 is a cross-sectional view illustrating the structure of an electret condenser microphone described in Japanese Unexamined Patent Application Publication No. 2002-345088. The electret condenser microphone is formed continuously with a semiconductor substrate.

In FIG. 5, a package 101 is composed of a holding chamber 101c into which air is prevented from flowing, a package body 101a, and a top cover 101b placed on the top end of the package body 101a so as not to permit the passage of air. In order to introduce an external sound pressure into the holding chamber 101c, the top cover 101b is provided with an air hole 102, and a semiconductor substrate 103 made of square silicon is placed in the holding chamber 101c. The semiconductor substrate 103 has a pair of opposed principal surfaces 103a and 103b. One of the principal surfaces (103b) is bonded to a bottom part of the package body 101a by a resin or soldering.

A recess 104 is formed in a middle part of the other principal surface 103a of the semiconductor substrate 103 to have a bottom surface 104a that is flat and parallel to the principal surface 103a and an inclined side surface 104b. A fixed electrode (rear electrode) 105 made of aluminum is formed on the bottom surface 104a of the recess 104. A silicon oxide film 106 is deposited on the peripheral top surface 103c of the semiconductor substrate 103. Furthermore, a square vibrating electrode 107 is fixed on the peripheral top surface 103c of the semiconductor substrate 103 so as to cover the recess 104 and be opposed to the rear electrode 105 with a space 108 interposed between the vibrating electrode 107 and the rear electrode 105. Anodic bonding is used to fix the vibrating electrode 107 on the peripheral top surface 103c of the semiconductor substrate 103.

The vibrating electrode 107 vibrates according to variations in the external sound pressure introduced into the holding chamber 101c, and the vibrating electrode 107 and the rear electrode 105 form a condenser. The vibrating electrode 107 is configured so that polypropylene 107a is coated with a surface electrode 107b made of aluminum. The polypropylene 107a forms a charged electret film.

In the electret condenser microphone (ECM) illustrated in FIG. 5, a space 108 for determining the capacity of the condenser is formed by etching the semiconductor substrate 103 with high accuracy. This etching with high accuracy allows the depth of the recess 104 to be controlled with high accuracy and can provide an ECM that is less likely to vary in performance. Furthermore, since the condenser can be formed continuously with the semiconductor substrate 103, a detection circuit for detecting signals from the condenser and other circuits can be formed on the semiconductor substrate 103. This can reduce the size of the ECM.

### SUMMARY OF THE INVENTION

Since the ECM illustrated in FIG. 5 is formed continuously with the semiconductor substrate 103, this can reduce variations in the performance of the ECM and the size thereof. However, when a vibrating electrode (or a fixed electrode) is formed with an electret film, this causes the following problems.

Polypropylene or any other material is used as a material of a known electret film. In general, a metal film is formed, by vapor deposition or any other method, on a polypropylene substrate formed by molding or any other method, thereby forming a vibrating electrode. Therefore, it is necessary for the substrate to have a certain thickness with reliability. This makes it difficult to reduce the thickness of the polypropylene substrate to submicron size or smaller. Therefore, the capacity of the condenser becomes small, because the size of the gap between the electrodes is determined by the thickness of the polypropylene substrate used as an electret material. More particularly, when a sound wave is detected by the condenser, the amount of the variation in the capacity of the condenser becomes small, resulting in the reduced sensitivity of the ECM.

Furthermore, since a polypropylene substrate having a certain thickness is used as an electret material, etching for patterning requires a long time, and fine patterning becomes difficult. This makes it difficult to reduce the size of the ECM.

Moreover, when a polypropylene substrate molded to have a small size is used, condenser microphones have to be separately fabricated. This significantly reduces the productivity of ECMs.

The present invention is made in order to solve the above-mentioned problems, and its main object is to provide a small, high-sensitivity electret condenser microphone with excellent productivity.

A condenser microphone according to the present invention includes a vibrating electrode, a fixed electrode, and an electret film formed between the vibrating electrode and the fixed electrode and is formed continuously with a semiconductor substrate. The electret film is made of one of an amorphous perfluoropolymeric resin and benzocyclobutene.

This structure facilitates a reduction in the thickness of the electret film and fine patterning. Furthermore, since the condenser microphone is formed continuously with the semiconductor substrate, this allows a small, high-sensitivity condenser microphone to be fabricated with excellent productivity.

In one preferred embodiment, films stacked on the semiconductor substrate may include the vibrating electrode, the fixed electrode and the electret film, and the electret film may be formed by applying a solution containing one of the amorphous perfluoropolymeric resin and benzocyclobutene onto the semiconductor substrate and patterning a film made of the applied solution.

In another preferred embodiment, a hollow portion may be formed in a portion of the condenser microphone located between the vibrating electrode and the fixed electrode. The hollow portion is preferably formed by partially removing a film formed on the semiconductor substrate.

In still another preferred embodiment, the electret film may be covered with a hydrophobic insulating film. The hydrophobic insulating film is preferably a silicon nitride film.

In yet another preferred embodiment, a signal processing circuit for processing a signal detected by the condenser microphone may be integrated on the semiconductor substrate.

Since the amorphous perfluoropolymeric resin or benzocyclobutene is used as a material of the electret film of the condenser microphone according to the present invention, the electret film can be formed on the semiconductor substrate by coating. This can easily reduce the thickness of the electret film. In addition, since fine patterning is easily achieved using an etching gas used in a semiconductor process, this can provide a small, high-performance electret condenser microphone.

The vibrating electrode, the fixed electrode and the hollow portion that form a condenser, as well as the electret film can be formed in the same manner as used in a semiconductor process, i.e., by film deposition, etching and other methods. This can facilitate forming an ECM integrated with the semiconductor substrate, resulting in sharply increased productivity.

### BRIEF DESCRIPTION OF THE DRAWINGS

FIG. 1 is a cross-sectional view schematically illustrating the structure of an electret condenser microphone (acoustic sensor) according to an embodiment of the present invention.

FIG. 2A through 2D are cross-sectional views illustrating process steps for fabricating an electret condenser microphone (acoustic sensor) according to the embodiment of the present invention.

FIG. 3 is a plan view illustrating the structure of the electret condenser microphone immediately after the process step illustrated in FIG. 2B.

FIG. 4 is a plan view illustrating the structure of the electret condenser microphone immediately after the process step illustrated in FIG. 2D.

FIG. 5 is a cross-sectional view illustrating the structure of a known electret condenser microphone.

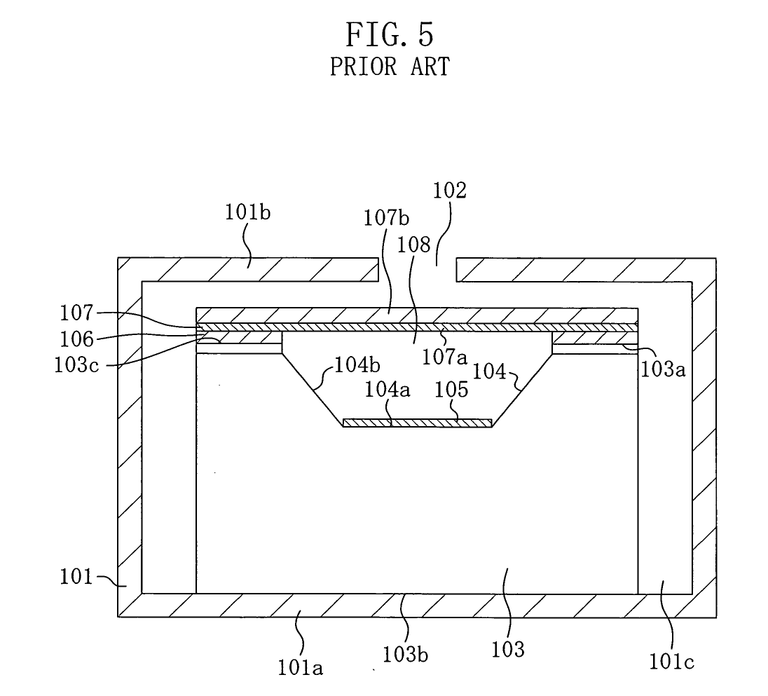

### DETAILED DESCRIPTION OF THE INVENTION

An embodiment of the present invention will be described hereinafter with reference to the drawings. For simplicity, components having substantially the same function are represented by the same reference numerals. The present invention is not limited to the embodiment described below.

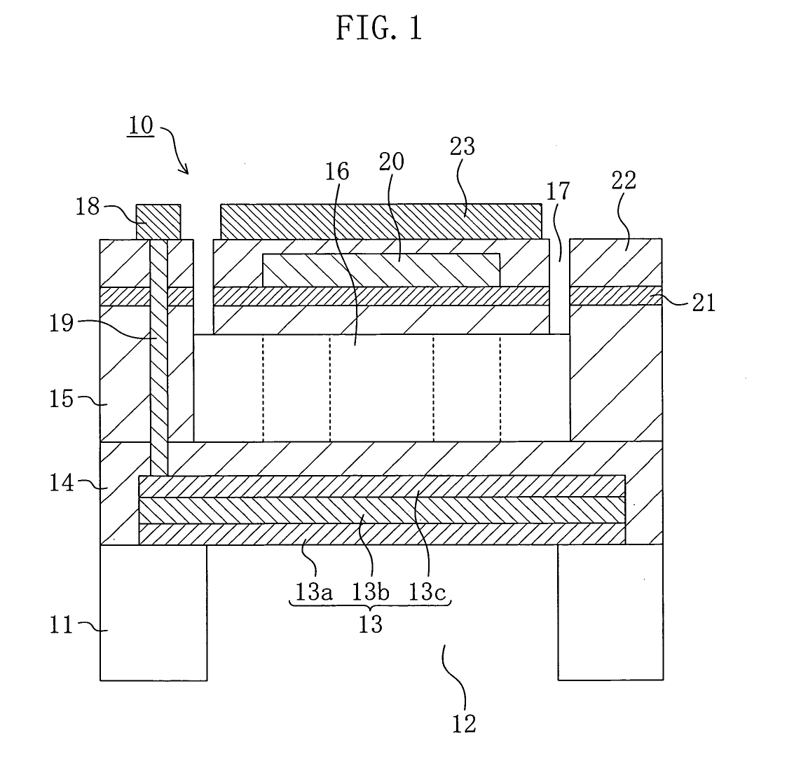

FIG. 1 is a cross-sectional view schematically illustrating the structure of an electret condenser microphone (acoustic sensor) 10 according to this embodiment.

As illustrated in FIG. 1, the electret condenser microphone (ECM) 10 according to this embodiment forms an air-gap capacitor structure in which an upper electrode (fixed electrode) 23 and a lower electrode (vibrating electrode) 13 are opposed to each other with a hollow portion 16 of the ECM 10 interposed therebetween and has an electret film 20 representing a charge retention material formed between the electrodes. The ECM 10 is formed continuously with a semiconductor substrate 11, and the electret film 20 is made of an amorphous perfluoropolymeric resin. The electret film 20 made of such a material can be formed on the semiconductor substrate 11 by spin coating as described below. This facilitates reducing the thickness of the electret film 20. In addition, the electret film 20 can be easily etched by a fluorine based gas used in a semiconductor process, thereby achieving fine patterning. This can reduce the area of the condenser.

A specific structure of the ECM 10 according to this embodiment will be described hereinafter with reference to FIG. 1.

As illustrated in FIG. 1, a lower electrode (vibrating electrode) 13 is formed on a part of a silicon substrate (semiconductor substrate) 11 in which a through hole 12 is formed to vibrate in response to a sound wave. The through hole 12 is formed by etching away part of the silicon substrate 11 to facilitate vibrating the lower electrode 13. The lower electrode 13 is configured to include tension films 13a and 13c and a polysilicon film 13b covered with the tension films 13a and 13c. The tension films 13a and 13c are configured to hold the polysilicon film 13b under a tension and thus facilitate vibrating the polysilicon film 13b and formed of films having a high tension, e.g., silicon nitride films.

A first insulating layer 14 and a second insulating layer 15 are formed to cover the lower electrode 13. The first and second insulating layers 14 and 15 are made of silicon oxide. However, they may be formed of silicon nitride films.

A hollow portion 16 of the electret condenser microphone is surrounded by the first and second insulating layers 14 and 15 and communicates with introduction holes 17. The height of the hollow portion 16 is approximately 300 nm through 2000 nm. A contact hole is formed to pass through the first and second insulating layers 14 and 15 and reach the lower electrode 13. Then, a contact plug 19 is formed by filling the contact hole with a metal, e.g., tungsten (W) or polysilicon, so as to be connected to an electrical interconnect 18.

An electret film 20 is formed on the second insulating layer 15 with a hydrophobic insulating film (hereinafter, referred to as “hydrophobic film”) 21 interposed therebetween. The perfluoropolymeric resin used as a material of the electret film 20 has a ring structure, therefore does not form a crystal structure and is amorphous. More particularly, the electret film 20 can be dissolved by a special fluorine-based solvent. Therefore, the electret film 20 can be formed by spin coating to have a small submicron thickness. Furthermore, the material of the electret film 20 can be easily subjected to dry etching using a fluorine based gas, e.g., a CF₄ gas, thereby achieving fine patterning of the electret film 20.

A hydrophobic film 22 protects the electret film 20 and serves to prevent moisture in the air from entering the electret film 20. A silicon nitride film forms a chemical bond with an electret material. Therefore, use of a silicon nitride film for the hydrophobic film 22 improves the adhesion between the hydrophobic film 22 and the electret film 20, resulting in the improved performance of the hydrophobic film 22 as a protective film.

An upper electrode (fixed electrode) 23 serving as an electrode of the condenser is formed on the hydrophobic film 22 and made of, for example, aluminum, platinum, copper, gold, or any other material.

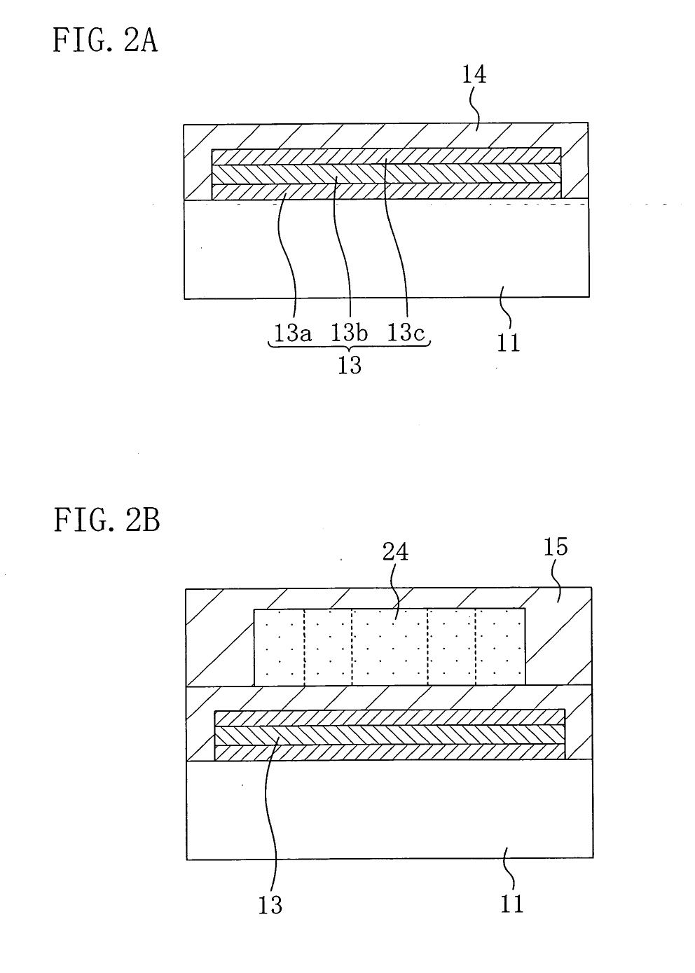

Next, a fabrication method for a condenser microphone according to this embodiment will be described with reference to the cross-sectional views illustrated in FIGS. 2A through 2D.

First, as illustrated in FIG. 2A, for example, a tension film 13a made of a silicon nitride film, a polysilicon film 13b that will serve as a lower electrode, and a tension film 13c made of a silicon nitride film are sequentially formed on a semiconductor substrate 11 to typically have thicknesses of approximately 0.1 μm, approximately 0.3 μm and approximately 0.1 μm, respectively. Subsequently, these films are subjected to selective dry etching to have the shape corresponding to a lower electrode 13, thereby forming a lower electrode 13. Next, a first insulating layer 14 made of, for example, silicon oxide is formed by chemical vapor deposition (CVD) to cover the semiconductor substrate 11 and the lower electrode 13.

Next, as illustrated in FIG. 2B, a sacrificial layer 24 made of, for example, polysilicon is deposited on the top surface of the first insulating layer 14 by CVD. The sacrificial layer 24 is subjected to selective dry etching to have the shape corresponding to a hollow portion 16.

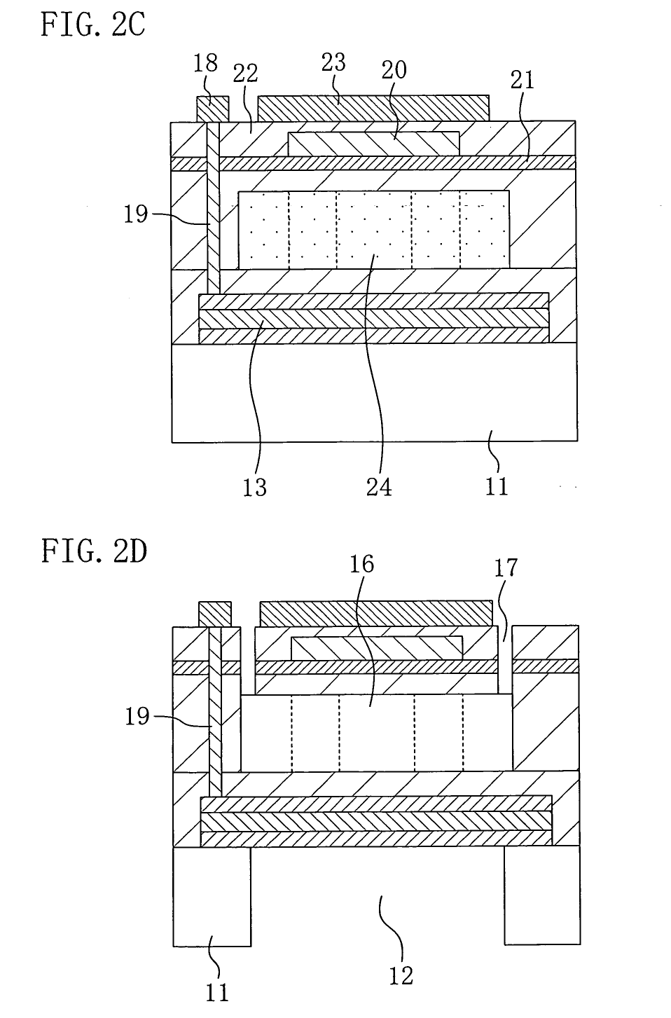

The sacrificial layer 24 is composed of a square body portion and attached portions extending outward from the edges of the body portion as illustrated in the plan view of FIG. 3.

Next, a second insulating layer 15 made of, for example, silicon oxide is deposited by CVD to cover the sacrificial layer 24 forming the shape of the hollow portion 16 and the first insulating layer 14. Thereafter, the top surface of the second insulating layer 15 is planarized by an etch-back process or chemical mechanical polishing (CMP).

Next, as illustrated in FIG. 2C, a hydrophobic film 21 made of a silicon nitride film is formed on the second insulating layer 15 by CVD. Thereafter, an electret film 20 is deposited on the hydrophobic film 21 by spin coating, and further the deposited electret film 20 is patterned by dry etching. The hydrophobic film 21 typically has a thickness of approximately 0.05 μm, and the electret film 20 typically has a thickness of approximately 0.5 μm.

A formation method for an electret film 20 will be described hereinafter in detail.

In order to form the electret film 20 by spin coating, an amorphous perfluoropolymeric resin is dissolved in a special solvent having a boiling point of 180° C. Next, this solution is allowed to drop onto the semiconductor substrate 11. Thereafter, the semiconductor substrate 11 is rotated at a rotational speed of 500 rpm for approximately 10 seconds and then at a rotational speed of 1000 rpm for approximately 20 seconds. Thereafter, the semiconductor substrate 11 is placed on a hot plate at a temperature of 180° C. for one hour so as to be dried. Under such circumstances, a 0.5-μm-thick electret film 20 can be uniformly formed with excellent reproducibility.

In this embodiment, a 0.5-μm-thick electret film 20 is formed. However, when the amount of charges to be deposited on the electret film 20 is to be increased, the electret film 20 can become thicker to the extent that it does not cause dielectric breakdown. However, when the electret film 20 has a thickness of 2 μm or more, the following steps are preferably carried out: A solution is allowed to drop onto a semiconductor substrate and then uniformly applied onto the substrate at an appropriate rotational speed for an appropriate period of time; thereafter the substrate is dried at a temperature of 50° C. for 30 minutes by a hot plate; the temperature of the hot plate is slowly increased to 180° C. in approximately an hour; and then the substrate is dried at a temperature of 180° C. for an hour. In this way, an electret film can be formed with excellent surface smoothness.

Next, a resist pattern is formed on the electret film 20, and then the electret film 20 is subjected to dry etching in a CF₄ gas atmosphere under the conditions of a pressure of 0.5 Torr and a power of 300 W. In this case, the etching rate is approximately 2 μm/min, and an etching process for the 0.5-μm-thick electret film 20 is completed in approximately 15 seconds.

A hydrophobic film 22 made of a silicon nitride film is formed by CVD to cover the electret film 20 formed by the above-mentioned method. The silicon nitride film 22 is deposited by CVD at a room temperature. Subsequently, the silicon nitride film 22 is planarized by CMP. Thereafter, a contact hole is selectively formed by dry etching and filled with a tungsten material, and then the tungsten material is polished by CMP, thereby forming a contact plug 19. Subsequently, an aluminum material is deposited on the silicon nitride film 22 by sputtering, and then the aluminum material is subjected to dry etching to selectively form an electrical interconnect 18 and an upper electrode 23 at the same time.

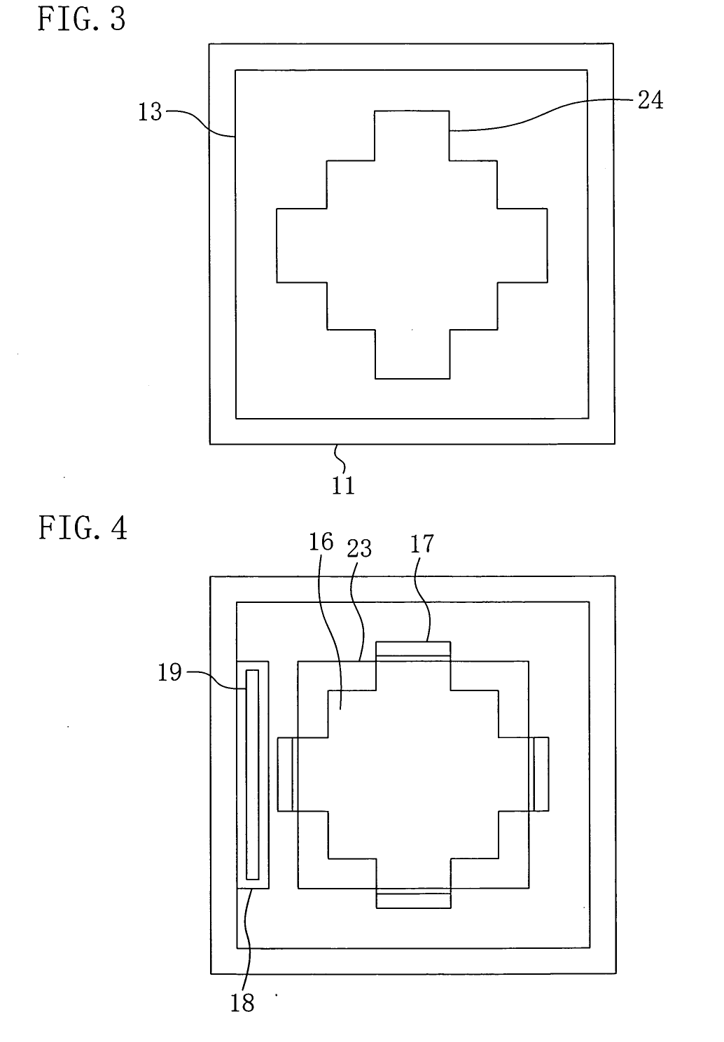

Next, as illustrated in FIG. 2D, introduction holes 17 for an etching gas is selectively formed by dry etching to etch away the sacrificial layer 24. The introduction holes 17 are formed on respective outer end parts of the attached portions of the sacrificial layer 24 as illustrated in the plan view of FIG. 4.

In a case where, for example, polysilicon is used as a material of the sacrificial layer 24, fluorine trichloride, xenon fluoride, or any other gas is introduced, as an etching gas, through the introduction holes 17 to the sacrificial layer 24, thereby completely removing the polysilicon. In this way, a hollow portion 16 is formed.

Finally, a through hole 12 is selectively formed by dry etching or wet etching using a tetramethylammonium hydroide (TMAH) solution as an etchant from the back surface of the semiconductor substrate 11. In this way, an ECM 10 is completed.

When signal processing circuits (not shown) for processing signals detected by the ECM 10 are integrated on the semiconductor substrate 11, this can further reduce the size of the ECM 10.

According to the above-described method, the lower electrode (vibrating electrode) 13, the upper electrode (fixed electrode) 23 and the hollow portion 16 that form a condenser, as well as the electret film 20 can be formed in the same manner as used in a semiconductor process, i.e., by film deposition, etching and other methods. This can facilitate forming an ECM integrated with the semiconductor substrate, resulting in sharply increased productivity.

As described above, use of an amorphous perfluoropolymeric resin as a material of the electret film 20 easily permits fine patterning by lithography and dry etching used in a semiconductor process. This can reduce the area of the condenser. Furthermore, since the amorphous perfluoropolymeric resin can be deposited by spin coating, this can reduce the thickness of the electret film 20, resulting in the increased capacity of the condenser.

Polypropylene used as a known electret material has low heat resistance and therefore can be used only in a low-temperature process step of a process for fabricating a condenser microphone. Hence, the electret material cannot be sufficiently protected by a closely-packed film. When polypropylene is used as the electret material, moisture in the air is likely to reach the electret film. Therefore, charges are hardly maintained in the electret film due to charge losses caused by moisture. On the other hand, since an amorphous perfluoropolymeric resin material used for the present invention has heat resistance up to approximately 300° C., the electret film can be covered with a silicon nitride film that is a closely-packed hydrophobic insulating film by CVD. Therefore, charges can be stored in the electret film for long hours.

When with the structure of the present invention polypropylene used as the known electret material was used as an electret material of the present invention, the surface potential of the electret film immediately after the deposition of charges on the electret film was 250 V at a temperature of 70° C. and a humidity of 90% while being reduced to 0V in two hours. When the amorphous fluoroplastic material of the present invention was used, the surface potential of the electret film immediately after the deposition of charges on the electret film was 250 V while being reduced only to 180V in 30 hours.

While the present invention was described above with reference to the preferred embodiment, the above description is not limited and can be certainly modified in various ways. Although in this embodiment, for example, an electret film 20 is formed near an upper electrode (fixed electrode) 23, it may be formed near a lower electrode (vibrating electrode) 13. Although a silicon nitride film is used as a material of a hydrophobic film 22, a silicon carbide film or any other film may be used thereas. Furthermore, benzocyclobutene can be used as a material of an electret film 20. The surface potential of the electret film for which benzocyclobutene was used immediately after the deposition of charges on the electret film was 250 V at a temperature of 70° C. and a humidity of 90% while being also reduced only to 220 V in 30 hours.

What is claimed is:

1. A condenser microphone comprising a vibrating electrode, a fixed electrode, and an electret film formed between the vibrating electrode and the fixed electrode,
the condenser microphone being formed continuously with a semiconductor substrate, and
the electret film being made of one of an amorphous perfluoropolymeric resin and benzocyclobutene.

2. The condenser microphone of claim 1, wherein
the vibrating electrode, the fixed electrode and the electret film are stacked on the semiconductor substrate, and
the electret film is formed by applying a solution containing one of the amorphous perfluoropolymeric resin and benzocyclobutene onto the semiconductor substrate and patterning a film made of the applied solution.

3. The condenser microphone of claim 1, wherein
a hollow portion is formed in a portion of the condenser microphone located between the vibrating electrode and the fixed electrode.

4. The condenser microphone of claim 3, wherein
the hollow portion is formed by partially removing a film formed on the semiconductor substrate.

5. The condenser microphone of claim 1, wherein
the electret film is covered with a hydrophobic insulating film.

6. The condenser microphone of claim 5, wherein
the hydrophobic insulating film is a silicon nitride film.

7. The condenser microphone of claim 1, wherein
a signal processing circuit for processing a signal detected by the condenser microphone is integrated on the semiconductor substrate.
